(19) United States
(12) Patent Application Publication
(10) Pub. No.: US 2017/0299195 A1
(43) Pub. Date: Oct. 19, 2017

(54) Cooktop Fire Prevention Module with Remote Control Cooking Features

(71) Applicant: General Electric Company, Schenectady, NY (US)

(72) Inventor: James Carter Bach, Seymour, IN (US)

(21) Appl. No.: 15/132,285

(22) Filed: Apr. 19, 2016

(51) Int. Cl. F24C 7/08; H05B 1/02; H05B 3/68

(52) U.S. Cl. CPC F24C 7/088; H05B 3/68; F24C 7/083; H05B 1/0202; H05B 1/0258

(57) ABSTRACT

A cooking appliance having a cooktop that is regulated by a fire prevention module is provided. In addition to its fire prevention and safety features, the fire prevention module includes a communication module that enables communication between the cooktop appliance and a remote device, such as a smartphone or tablet computer. Using this communication link, the fire prevention module can be used to expand the ability of a user to monitor and/or control operation of the cooktop appliance from a remote location. For example, using a software application on their smartphone, a user may monitor the temperature of a cooking utensil and initiate a particular cooking profile, or be notified when an unsafe cooking condition might be present and that the cooktop unit has been automatically deactivated to remedy the situation.

### FIELD OF THE INVENTION

The present disclosure relates generally to cooktop appliances, or more specifically, to a fire prevention module for a cooktop appliance that enables remote monitoring and cooking control features.

### BACKGROUND OF THE INVENTION

Cooking appliances, such as, e.g., cooktops (also known as hobs or surface cooking appliances) or ranges (also known as stoves, which combine a cooktop with an oven), and referred to herein generally as “Cooktop Appliances,” generally include one or more heated portions for heating or cooking food items within a cooking utensil placed on the heated portion. The heated portions utilize one or more heating sources to output heat, which is transferred to the cooking utensil and thereby to any food item or items within the cooking utensil. Typically, a controller or other control mechanism, such as an electromechanical switch, regulates the heat output of the heating source selected by a user of the cooking appliance, e.g., by turning a knob or interacting with a touch-sensitive control panel. For example, the controller, or electromechanical switch, may cycle the heating source between an activated or “on” state and a deactivated or “off” state such that the average heat output approximates the user-selected heat output.

However, the transfer of heat to the cooking utensil and/or food items may cause the food items or cooking utensil to overheat or otherwise cause unwanted and/or unsafe conditions on the cooktop appliance. For example, heating cooking oil past a certain temperature point can result in a fire. For instance, a high power level setting may cause a frying pan or skillet containing only a thin layer of cooking oil to quickly rise in temperature because the thermal masses of the cooking utensil and cooking oil are small. In some cases, the temperature may rise such that the oil self-ignites. On the other hand, a high power level setting typically does not lead to dangerous conditions for large food loads, e.g., a pot filled with water, because the large thermal mass slows the rate at which the cooking utensil and food heat up and, in this particular example, because water is both a self-temperature-regulating compound (i.e., it boils at 100° C. and converts itself to steam) and is not a self-igniting chemical compound (i.e., water doesn't burn).

As a result, applicable regulations (e.g. UL 858) in the cooking appliance industry will soon require certain types of cooktop appliances, in particular, those with open-coil electric heating elements (commonly referred to as “Coil Cooktops” or “Coil Ranges”) to include control modules or other features that regulate operation of the heating element in order to limit cooking utensil temperatures below a predetermined threshold temperature, e.g., the temperature at which cooking oil self-ignites (known to be approximately 400° C.). These control modules, referred to herein generally as fire prevention modules, require appliance manufacturers to redesign or retrofit cooking appliances to comply with the revised regulations (e.g. UL 858).

As appliance manufacturers redesign or retrofit cooktop appliances to incorporate fire prevention modules, or to modify their existing controllers, the cost of the cooktop appliances increases, but the user does not experience a perceived benefit from the increased cost. This additional cost may be very undesirable for consumers, particularly consumers of electric coil cooktop appliances which tend to be the lower-end (least costly) types of cooktops or ranges. Electric coil cooktop appliances tend to be controlled by electronic controllers with minimal functionality and expandability; in fact, a very large percentage of these units have no controller at all, and the heating element's power level is controlled by a device known as an “Infinite Switch” (aka a “knob” which the consumer turns). Particularly on these lower-end (inexpensive) electric coil cooktop appliances the addition of the fire prevention module adds significant costs, but the users see little or no benefit from those costs. Consumer dissatisfaction may result if consumers do not see a benefit from the added cost of the fire prevention module during normal cooking operations.

Accordingly, a cooktop appliance that enables a user to realize additional, tangible, demonstrable benefits from the mostly-transparent, regulation-required fire prevention module would be useful. More particularly, a fire prevention module that enables a user to remotely monitor and control certain aspects of the operation of the cooktop appliance using the fire prevention module would be especially beneficial.

### BRIEF DESCRIPTION OF THE INVENTION

The present subject matter provides a cooktop appliance having a surface cooking zone that is regulated by a fire prevention module. In addition to its fire prevention and safety features, the fire prevention module includes a communication module that enables communication between the cooktop appliance and a remote device, such as a smartphone or tablet. Using this communication link, the fire prevention module can be used to expand the ability of a user to monitor and control operation of the cooktop appliance. For example, using a software application on their smartphone, a user may monitor the temperature of a cooking utensil and initiate a particular cooking profile. Additional aspects and advantages of the invention will be set forth in part in the following description, may be apparent from the description, or may be learned through practice of the invention.

In one exemplary embodiment, a cooking appliance is provided. The cooking appliance a heating source configured for heating a cooking utensil placed upon an upper surface of the cooking appliance. A temperature sensor is positioned to sense the temperature of a cooking utensil placed upon or immediately above the heating source. An energy control device is configured for regulating a source of heating energy supplied to the heating source. A communication module is configured to send data to and/or receive data from a remote device and a controller is in operative communication with the temperature sensor, the energy control device, and a remote device via the communication module. The controller is configured for monitoring the temperature of the cooking utensil using the temperature sensor, operating the energy control device to reduce the heating energy supplied to the heating source when the measured temperature of the cooking utensil indicates that an unsafe operating condition exists or is imminent, and communicating with the remote device by performing at least one of sending appliance operating status information to the remote device or receiving an appliance control command from the remote device.

In another exemplary embodiment, a method of using a remote device to monitor and control a cooking appliance using a fire prevention module of the cooking appliance is provided. The method includes operating an energy control device to selectively provide heating energy to a heating source on an upper surface of the cooking appliance and monitoring the temperature of a cooking utensil being heated by the heating source of the cooking appliance using a temperature sensor to measure the temperature of the cooking utensil. The energy control device is operated to reduce the heating energy supplied to the heating source when a measured temperature of the cooking utensil indicates that an unsafe operating condition exists or is imminent. The energy control device communicates with the remote device by performing at least one of sending appliance operating status information to the remote device or receiving an appliance control command from the remote device.

In still another exemplary embodiment, a fire prevention and control system is provided. The fire prevention and control system includes a cooking appliance including a heating source configured for heating a cooking utensil placed upon an upper surface of the cooking appliance and a temperature sensor configured for measuring the temperature of the cooking utensil placed upon or immediately above the heating source. A cooktop control unit includes a communication module and being in operative communication with the temperature sensor and a remote device via the communication module. The cooktop control unit is configured for monitoring the temperature of the cooking utensil using the temperature sensor and selectively deactivating the heating source to reduce the temperature of the cooking utensil when the measured temperature indicates that an unsafe operating condition exists or is imminent. The remote device is in communication with the cooking appliance through the communication module, the remote device being configured to perform at least one of receiving appliance operating status information from the cooktop control unit or sending at least one control command to the cooktop control unit.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side, perspective view of a cooking appliance according to an exemplary embodiment of the present subject matter.

FIG. 2 provides a top, perspective view of a heating element assembly of the cooking appliance of FIG. 1 according to an exemplary embodiment of the present subject matter.

FIG. 3 provides a cross-section view of the heating element assembly of FIG. 2, taken along Line 3-3 of FIG. 2.

FIG. 4 provides a schematic view of a fire prevention module configured to enable remote cooking features according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

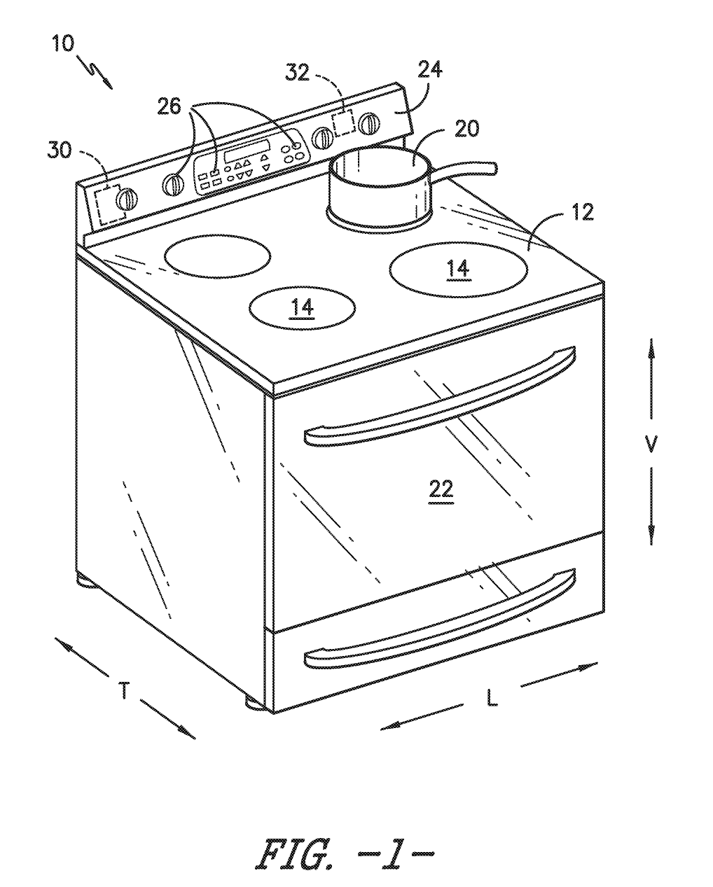

Referring now to the drawings, wherein identical numerals indicate the same elements throughout the figures, FIG. 1 is a side, perspective view of a cooking appliance 10 according to an exemplary embodiment of the present subject matter. Cooking appliance 10 may be a range (i.e., stove) appliance as shown in FIG. 1. However, cooking appliance 10 is provided by way of example only and is not intended to limit the present subject matter in any aspect. Thus, the present subject matter may be used with other cooking appliance configurations, e.g., cooktop appliances without an oven, such as one might find in a kitchen island. Further, the present subject matter may be used in any other suitable appliance.

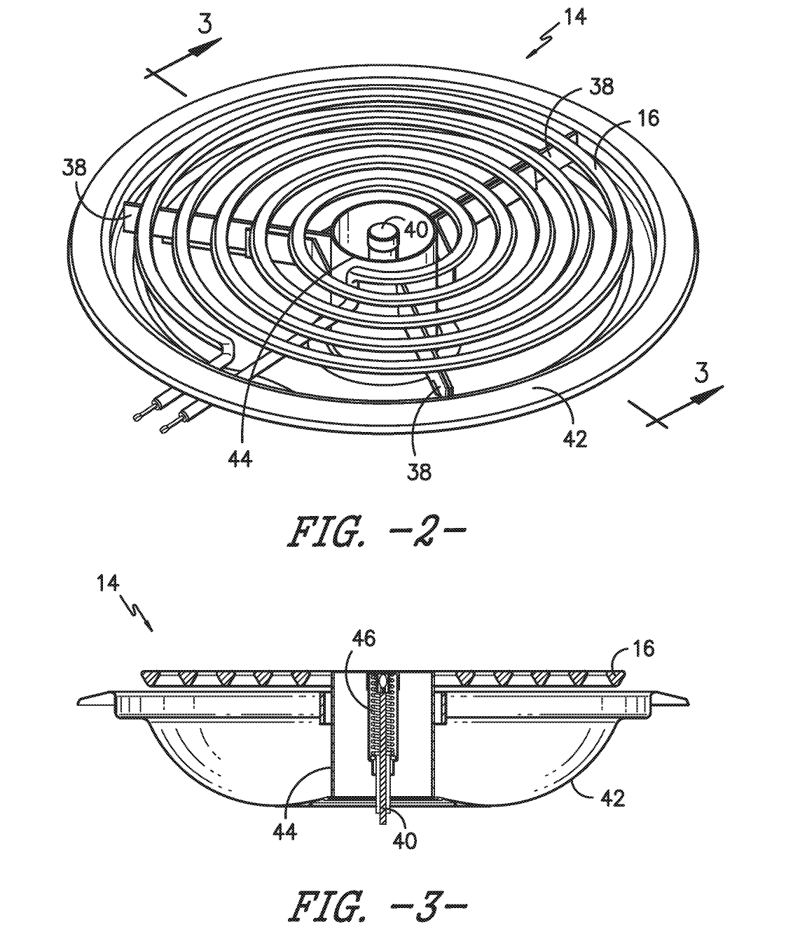

Cooking surface 12 of cooking appliance 10 includes heating element assemblies 14 having heating sources, such as heating elements 16 (as illustrated in FIG. 2). In some embodiments, cooking appliance 10 may be a radiant cooktop appliance, and cooking surface 12 may be constructed of a glass, ceramic, or a combination glass-ceramic material, or any other suitable material. Heating elements 16 may be, e.g., electrical resistive heating elements and/or any other suitable heating element. Alternatively, cooking appliance 10 may include a gas cooktop, and heating element 16 could be a gas burner. An electronically controlled gas valve may be configured to regulate the flow of gas to the gas burner. In addition, heating elements 16 may include a support structure for supporting a cooking utensil placed above heating element 16 (e.g., a grate positioned over the gas burner).

Each heating element assembly 14 of cooking appliance 10 may be heated by the same type of heating element 16, or cooking appliance 10 may include a combination of different types of heating elements 16. Further, heating element assemblies 14 may have any suitable shape and size, and cooking appliance 10 may include a combination of heating element assemblies 14 of different shapes and sizes. One skilled in the art will appreciate that a variety of different heating sources may be used while remaining within the scope of the present subject matter.

As shown in FIG. 1, a cooking utensil 20, such as a pot, pan, or the like, may be placed on a heating element assembly 14 to cook or heat food items placed in cooking utensil 20. Cooking appliance 10 also includes a door 22 that permits access to a cooking chamber (i.e., oven cavity, not shown) of appliance 10, the cooking chamber for cooking or baking of food or other items placed therein. A control panel 24 having controls 26 permits a user to make selections for cooking of food items using heating element assemblies 14 and/or the cooking chamber. Although shown on a backsplash or back panel of cooking appliance 10, control panel 24 may be positioned in any suitable location, such as the front bezel (i.e., above the oven door). Controls 26 may include buttons, knobs, touch-sensitive areas, and the like, as well as combinations thereof. As an example, a user may manipulate one or more controls 26 to select, e.g., a power level for each heating element assembly 14. The selected power level of heating element assembly 14 affects the heat transferred to cooking utensil 20 placed on heating element assembly 14, as further described below.

The operation of cooking appliance 10, including heating elements 16, may be controlled by a processing device such as an appliance controller 30, which may include a microprocessor or other device that is in operative communication with components of appliance 10. Appliance controller 30 may include a memory and microprocessor, such as a general or special purpose microprocessor operable to execute programming instructions or micro-control code associated with a cleaning cycle. The memory may represent random access memory such as DRAM or SRAM, and/or read only memory such as ROM or FLASH. In one embodiment, the processor executes programming instructions stored in memory. The memory may be a separate component from the processor or may be included onboard within the processor. Alternatively, appliance controller 30 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Appliance controller 30 may be in operative communication with various components of cooking appliance 10, e.g., heating elements 16 and controls 26 such that, in response to user manipulation of controls 26, appliance controller 30 operates the various components of cooking appliance 10 to execute selected cycles and control various features of appliance 10. Appliance controller 30 may also be in communication with a temperature sensor 40 (FIG. 2), and may use measurements provided by temperature sensor 40 to control the power level of heating element 16 to regulate the temperature or heat output of heating element assembly 14, e.g., to a temperature or heat level selected by the user via controls 26. Controls 26 and other components of cooking appliance 10 may be in communication with appliance controller 30 via one or more signal lines or shared communication busses.

Cooking appliance 10 may further include a fire prevention module 32. According to some exemplary embodiments, fire prevention module 32 may be a part of controller 30. However, according to the illustrated exemplary embodiment of FIG. 1, fire prevention module 32 is a separate, dedicated control module configured for deactivating heating element 16 or reducing the power supplied to heating element 16 when an unsafe operating condition exists or is imminent. An unsafe operating condition may be related to the temperature of cooking utensil 20, heating element 16, or any other component of cooking appliance 10. Alternatively, the unsafe operating condition may related to an electrical or power fault, a fuel supply issue, or the detection of smoke within the vicinity of cooktop appliance 10. One skilled in the art will appreciate that these unsafe operating conditions are only exemplary, and that other unsafe operating conditions may be possible and within the scope of the present subject matter.

Moreover, fire prevention module 32 may deactivate heating element 16 even before an unsafe operating condition exists. In this regard, fire prevention module 32 may be configured to predict when an unsafe operating is imminent or soon to occur, and may proactively deactivate heating element 16 to avoid the unsafe operating condition. In order to predict such a condition, controller 30 may implement a variety of control algorithms based on feedback related to a variety of system parameters, settings, and sensed conditions, to accurately predict and prevent the unsafe operating condition.

For example, according to an exemplary embodiment, the unsafe operating condition may be when the temperature of cooking utensil 20 exceeds a predetermined threshold. The predetermined threshold may be, for example, somewhat below the temperature at which oil in cooking utensil 20 would ignite. In this manner, fire prevention module 32 acts as a safety device that regulates the temperature of cooking utensil 20 to reduce or eliminate the risk of fires. Operation of fire prevention module 32 will be described in more detail below in reference to FIG. 4.

FIG. 2 provides a top view of a heating element assembly 14 according to an exemplary embodiment of the present subject matter. In the illustrated exemplary embodiment, heating element 16 is a coil (spiral) shaped electrical resistive heating assembly; that is, FIG. 2 illustrates a heating assembly 14 for an electric coil cooking appliance. Cooking utensils 20 are placed directly on heating element 16 of the illustrated cooking appliance 10. As shown, heating element 16 may be supported by one or more support elements 38, which also help support cooking utensil 20 when placed on heating element 16. Moreover, in the depicted embodiment of assembly 14, temperature sensor 40 is positioned approximately in the center of heating element assembly 14. Temperature sensor 40 may used, e.g., to measure the temperature of a cooking utensil 20 placed on the respective heating element assembly 14 and provide such temperature measurements to appliance controller 30. Temperature sensor 40 is positioned such that sensor 40 contacts a bottom surface of cooking utensil 20 (FIG. 1) when cooking utensil 20 is placed on heating element 16 of assembly 14. Positioning temperature sensor 40 approximately in the center of heating element assembly 14 may help ensure that temperature sensor 40 contacts a cooking utensil 20 placed on heating element 16 no matter the size or shape of utensil 20.

One skilled in the art will appreciate that any suitable type of temperature sensor or sensors may be used and that the temperature sensor(s) may be positioned at any location suitable for measuring the temperature of cooking utensil 20. For example, one skilled in the art would also recognize that there are non-contacting temperature measurement schemes, e.g., an infrared pyrometer, which could be used to sense the temperature of the bottom of cooking utensil 20 by looking-up from below. Such a cooking utensil temperature sensing scheme could also be utilized provided that it was adequately designed to ignore the thermal radiation from heating element 16. Additionally, one skilled in the art could also recognize that a non-contacting infrared pyrometer could be positioned above cooking appliance 10, looking-down into cooking utensil 20 from above, thusly measuring the temperature of cooking utensil 20 and/or the food placed therein, and providing the temperature measurement through a data link to fire prevention module 32.

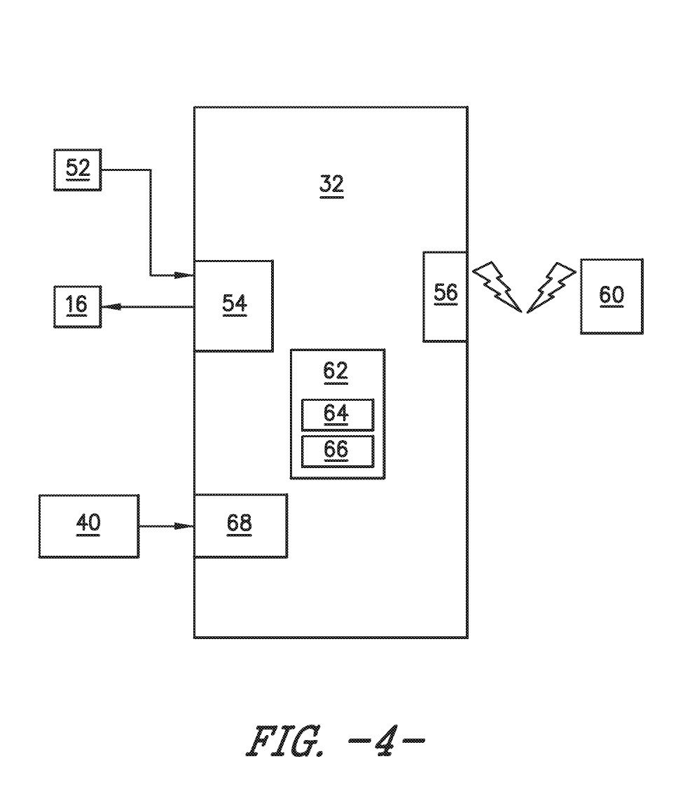

FIG. 3 provides a cross-section view of heating element assembly 14 shown in FIG. 2. As illustrated, heating element assembly 14 may have a generally semi-circular cross-section, but in other embodiments, heating element assembly 14 may have other cross-sectional shapes. In the depicted embodiment, heating element assembly 14 includes a drip pan 42 positioned below heating element 16 along the vertical direction V. Drip pan 42 may help collect any spills, boil-overs, or other debris from cooking activities or other uses of cooking appliance 10. Further, as most clearly shown in FIG. 2, a thermal shield 44 extends circumferentially about temperature sensor 40. Thermal shield 44 may be provided to minimize convective airflow and/or direct radiation of heat onto the temperature sensor 40 from heating element 16, which could negatively impact the temperature readings or measurements of sensor 40, e.g., by artificially elevating the temperature sensed by temperature sensor 40. As shown, shield 44 may be generally cylindrical in shape, but other shapes may be used as well.

Preferably, temperature sensor 40 is a spring-loaded sensor as depicted in FIG. 3. Spring-loaded temperature sensor 40 includes a spring 46 that helps position sensor 40 in contact with the bottom surface of cooking utensil 20 positioned on heating element 16. Further, spring 46 assists in keeping temperature sensor 40 in contact with the bottom surface while utensil 20 remains on heating element 16. Keeping sensor 40 in contact with the bottom surface facilitates more accurate measurements of the temperature of cooking utensil 20. Improving accuracy in measuring the temperature of cooking utensil 20 helps controller 30 better control the power provided to heating element 16, e.g., to ensure heating element 16, cooking utensil 20, and/or food items within utensil 20 do not exceed a maximum temperature or to ensure heating element 16 provides the desired amount of heat to cooking utensil 20. Of course, temperature sensor 40 may have other configurations appropriate for measuring the temperature of cooking utensil 20 positioned on heating element 16 and/or the temperature of food items placed within cooking utensil 20.

Referring now to FIG. 4, a schematic diagram of fire prevention module 32 of cooking appliance 10 is provided. Fire prevention module 32 may be in operative communication with various components of cooking appliance 10, e.g., a heating source such as heating element 16 and temperature measurement device such as temperature sensor 40 such that, in response to the measured temperature of cooking utensil 20, fire prevention module 32 may use an energy control device 54 to regulate the power supplied from a power source to heating element to, e.g., decrease or stop the flow of power to heating element 16. As an example, during normal operation, heating element 16 may be heated from a power source 52. Fire prevention module 32 may be in operative communication with a energy control device 54 that interrupts the flow of current from power source 52 to control the current provided to heating element 16 to thereby control the heat output of heating element 16.

Energy control device 54 may be, e.g., a relay, a bidirectional triode thyristor (i.e., a triode for alternating current or TRIAC) or the like. In some embodiments, cooking appliance 10 also may include a thermo-mechanical switch or other thermo-mechanical device to control the temperature or heat output of heating element 16. For example, a thermo-mechanical device such as a bi-metal infinite switch may be provided to control the duty cycle of heating element 16, e.g., by opening or closing to regulate the amount of time heating element 16 is on during the duty cycle. In other embodiments, such as the exemplary embodiment of FIG. 4, mechanical device may be included in addition to energy control device 54.

Additionally, fire prevention module 32 may also include a communication module 56 to facilitate communications between a remote device 60 and various other components of cooking appliance 10. For instance, the communication module 56 may be configured to send and receive one or more data signals and to serve as an interface between fire prevention module 32 and remote device 60. In this manner, communication module 56 enables fire prevention module 32 to transmit and/or receive information with remote device 60, thereby enabling monitoring and control of cooking appliance 10 from remote device 60.

According to the illustrated embodiment, communication module 56 is a wireless communication module 56 that establishes a direct communication link to enable transfer of information with remote device 60. For example, communication module 56 may communicate wirelessly with remote device 60 directly using Bluetooth communications (i.e., IEEE 802.15 communication protocol).

Alternatively, remote device 60 and wireless communication module 56 may be in wireless communication through any suitable wireless communications network (not shown) and by using any suitable wireless communication protocol. For example, communication module 56 may communicate indirectly with remote device 60 using a home wireless network, e.g., using WiFi (i.e., IEEE 802.11 communication protocol) with a WiFi router or other wireless access point. Such a configuration would allow remote device 60 to communicate with communication module 56 even when it is out of the typical 30 foot range associated with Bluetooth communications.

Moreover, one skilled in the art will appreciate that any number of intermediary computing devices and/or network devices may exist within a network to transmit communications between communication module 56 and remote device 60, and networks incorporating such intermediary devices are deemed to be within the scope of the present subject matter. For example, communication module 56 and remote device 60 may communicate via the internet, e.g., remote device 60 may communicate with an internet service provider (ISP) via a WiFi or mobile data connection which similarly communicates via the internet to communication module 56.

In certain exemplary embodiments, the wireless communications network may be a wireless personal area network (such as a Bluetooth communication network), a wireless local area network (WLAN), a point-to point communication networks (such as radio frequency identification networks, near field communications networks, etc.), or a combination of two or more of the above communications networks. Indeed, communications between remote device 60 and communication module 56 may be achieved using any suitable wireless communication protocol, for example, WiFi, ZigBee, Bluetooth, and others. According to another exemplary embodiment, communication module 56 may communicate with remote device 60 via a wired connection, either directly, or indirectly through a home network (e.g., direct wire using RJ-45 Ethernet cable).

Remote device 60 may be any device suitable for communicating with cooking appliance 10, e.g., receiving operating information from and sending control inputs to cooking appliance 10. According to the illustrated embodiment, remote device 60 is a smartphone or tablet configured for remote monitoring and control of cooking appliance 10. More specifically, remote device 60 may include a software application that allows a user to communicate with cooking appliance 10, e.g., to monitor and control its operation. According to alternative embodiments, any suitable computing device may be used as remote device 60.

According to the illustrated embodiment of FIG. 4, fire prevention module 32 may include a fire prevention controller 62. Various components of exemplary controller 62 are illustrated in schematic fashion in FIG. 4. As shown, controller 62 may include one or more processor(s) 64 and associated memory device(s) 66 configured to perform a variety of computer-implemented functions (e.g., performing the methods, steps, and the like disclosed herein). By way of example, processor 64 may include one or more microprocessors, such as general or special purpose microprocessors operable to execute programming instructions or micro-control code associated with an operating cycle. Memory 66 may represent random access memory such as DRAM or SRAM, or read only memory such as ROM or FLASH. In one embodiment, processor 64 executes programming instructions stored in memory 66. Memory 66 may be a separate component from processor 64 or may be included onboard within processor 64.

According to some exemplary embodiments, fire prevention module 32 may further include one or more sensor interfaces 68 (e.g., one or more analog-to-digital converters) to permit input signals to be converted into signals that can be understood and processed by fire prevention controller 62 of fire prevention module 32. In this manner, sensor interface 68 may receive and process signals from components of cooking appliance 10, e.g., sensors and control inputs. For example, sensor interface 68 of fire prevention module 32 may receive and process signals from temperature sensor 40.

It should be appreciated that the invention is not limited to any particular style, model, or configuration of cooking appliance 10. The exemplary embodiment depicted in FIGS. 1 through 3 is for illustrative purposes only. For example, fire prevention module 32 may be a part of appliance controller 30 instead of a stand-alone control module, different configurations of fire prevention module are possible, alternative communications protocol may be used, and other differences may be applied as well.

Now that the construction and configuration of cooking appliance 10 according to an exemplary embodiment of the present subject matter have been presented, an exemplary method of using remote device 60 to monitor and control cooking appliance 10 using fire prevention module 32 will be described. The method described below refers to communication and operation of an appliance, such as cooking appliance 10, using fire prevention module 32 according to exemplary embodiments of the present subject matter. It should be understood that the methods described may be used in other cooking appliances as well, such as range oven appliances.

For example, although cooking appliance 10 is described above as being an electric coil cooking appliance having coil shaped electrical resistive heating elements, one skilled in the art will appreciate that other types of cooking appliances may be used as well. For example, cooking appliance 10 could be a gas cooktop, and heating element 16 could be a gas burner. Similarly energy control device 54 could be an electronically controlled gas valve configured to stop or limit the flow of gas to the gas burner when the temperature of cooking utensil 20 exceeds a predetermined temperature. Aspects of the present subject matter may be applied to other types of cooktop as well, e.g., induction cooktops.

According to an exemplary embodiment, fire prevention module 32 is configured to receive a control command, e.g., a control input from remote device 60 using communication module 56 and regulate heating element 16 in accordance with that control input. The control input may generally be any operating parameter of cooking appliance 10. For example, control input may be a power level of heating element 16 or the adjustment of any parameter that may be controlled using controls 26 or controller 30. Specific examples of control inputs to cooking appliance 10 may include: initiating a temperature-controlled cooking profile; reducing or turning off the heating element; operating the heating element according to a time-dependent cooking profile; locking-out (child-proofing) the heating element; and setting a temperature to which the cooking utensil should be regulated. One skilled in the art will appreciate that other control inputs may be sent by remote device 60 to fire prevention module 32 using communication module 56, and such other control inputs are within the scope of the present subject matter.

According to an exemplary embodiment, fire prevention module 32 is configured to transmit, and remote device 60 is configured to receive, operating information related to cooking appliance 10. The operating information may generally include any operating parameter or performance data related to the operation of cooking appliance 10. For example, operating information may relate to the control inputs received by controls 26 (i.e., user-specified power level of the heating source), the temperature of cooking utensil 20, or other information related to operation of cooking appliance. Specific examples of operating information may include: an indication that energy control device 54 has reduced the heating energy supplied to heating element 16 because an unsafe operating condition has occurred or is imminent, e.g., the measured temperature of cooking utensil 20 has exceeded the predetermined threshold temperature; a power level of heating element 16 that is manually set using controls 26; a measured temperature of cooking utensil 20; an amount of time that heating element 16 has been energized; and an indication that an unsafe operating condition exists. One skilled in the art will appreciate that other operating information may be sent by fire prevention module 32 to remote device 60 using communication module 56, and such other operating information is within the scope of the present subject matter.

Notably, by adding communication module 56 to fire prevention module 32, remote monitoring and control of cooking appliance 10 may be achieved using a remote device 60, such as a smartphone. This user-friendly and beneficial feature would increase consumer satisfaction with cooking appliance 10 while adding minimal extra cost above the hardware that would be required to meet new safety regulations. Particularly on lower-end (inexpensive) electric coil cooktops, which do not typically have a controller that can support a fire prevention module and therefore must use an added, stand-alone control module to meet the regulation, the addition of a communication module adds relatively minimal costs and provides a functionality that consumers will find appealing. Therefore, fire prevention module 32 may provide additional functionality to cooking appliance 10, which many consumers will appreciate and use frequently. In this manner, the additional cost of the required fire prevention module 32 may be made more palatable to consumers.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A cooking appliance comprising:
a heating source configured for heating a cooking utensil placed upon an upper surface of the cooking appliance;
a temperature sensor positioned to sense the temperature of a cooking utensil placed upon or immediately above the heating source;
an energy control device configured for regulating a source of heating energy supplied to the heating source;
a communication module configured to send data to and/or receive data from a remote device; and
a controller in operative communication with the temperature sensor, the energy control device, and a remote device via the communication module, the controller being configured for:
monitoring the temperature of the cooking utensil using the temperature sensor;
operating the energy control device to reduce the heating energy supplied to the heating source when the measured temperature of the cooking utensil indicates that an unsafe operating condition exists or is imminent;
communicating with the remote device by performing at least one of sending appliance operating status information to the remote device or receiving an appliance control command from the remote device.

2. The cooking appliance of claim 1, wherein the appliance control command comprises at least one of:
reducing the power of, or turning off, the heating source;
setting a power level to which the cooking utensil should be heated;
locking the heating source in an “off” mode;
initiating a temperature-controlled cooking profile; and
operating the heating source according to a time-dependent cooking profile.

3. The cooking appliance of claim 1, wherein the appliance operating status information comprises at least one of:
an indication that an unsafe operating condition exists or is imminent;
a notification that the heating source's power level has been reduced to prevent an unsafe operating condition from occurring;
a measured temperature of the cooking utensil;
a power level of the heating source that is manually set at the cooktop appliance; and
an amount of time that the heating source has been energized.

4. The cooking appliance of claim 1, wherein the communication module is a wireless communication module that enables the remote device to communicate wirelessly with the controller of the cooking appliance to receive the appliance operating status information or send the appliance control command or both.

5. The cooking appliance of claim 1, wherein the cooking appliance comprises an electric cooktop, the heating source is an electric heating element, and the energy control device is a relay for reducing or stopping electrical energy (i.e. power) delivered to the electric heating element.

6. The cooking appliance of claim 1, wherein the cooking appliance comprises a gas cooktop, the heating source is a gas burner, and the energy control device is an electronically-actuated gas valve for reducing or stopping the flow of gas (i.e. chemical energy) to the gas burner.

7. The cooking appliance of claim 1, wherein the remote device is any of a smartphone, a tablet computer, a desktop computer, a laptop computer or other electronic device, and having a software application that allows a user to communicate with the cooking appliance.

8. A method of using a remote device to monitor and control a cooking appliance using a fire prevention module of the cooking appliance, the method comprising:
operating an energy control device to selectively provide heating energy to a heating source on an upper surface of the cooking appliance;
monitoring the temperature of a cooking utensil being heated by the heating source of the cooking appliance using a temperature sensor to measure the temperature of the cooking utensil;
operating the energy control device to reduce the heating energy supplied to the heating source when a measured temperature of the cooking utensil indicates that an unsafe operating condition exists or is imminent; and
communicating with the remote device by performing at least one of sending appliance operating status information to the remote device or receiving an appliance control command from the remote device.

9. The method of claim 8, the unsafe operating condition comprises a condition where the measured temperature of the cooking utensil exceeds a predetermined threshold temperature.

10. The method of claim 8, wherein the appliance control command comprises at least one of:
reducing the power of, or turning off, the heating source;
setting a power level to which the cooking utensil should be heated;
locking the heating source in an “off” mode;
initiating a temperature-controlled cooking profile; and
operating the heating source according to a time-dependent cooking profile.

11. The method of claim 8, wherein the appliance operating status information comprises at least one of:
an indication that an unsafe operating condition exists or is imminent;
a notification that the heating source's power level has been reduced to prevent an unsafe operating condition from occurring;
a measured temperature of the cooking utensil;
a power level of the heating source that is manually set at the cooktop appliance; and
an amount of time that the heating source has been energized.

12. The method of claim 8, wherein the remote device is any of a mobile phone, a tablet computer, a desktop computer, a laptop computer, or other electronic device, and having a software application that allows a user to communicate with the cooking appliance.

13. The method of claim 8, wherein the cooking appliance comprises an electric cooktop, the heating source is an electric heating element, and the energy control device is a relay for reducing or stopping electrical energy (i.e. power) delivered to the electric heating element.

14. The method of claim 8, wherein the cooking appliance comprises a gas cooktop, the heating source is a gas burner, and the energy control device is an electronically-actuated gas valve for reducing or stopping the flow of gas (i.e. chemical energy) to the gas burner.

15. A fire prevention and control system comprising:
a cooking appliance comprising:
a heating source configured for heating a cooking utensil placed upon an upper surface of the cooking appliance;
a temperature sensor configured for measuring the temperature of the cooking utensil placed upon or immediately above the heating source; and
a cooktop control unit comprising a communication module and being in operative communication with the temperature sensor and a remote device via the communication module, the cooktop control unit being configured for:
monitoring the temperature of the cooking utensil using the temperature sensor; and
selectively deactivating the heating source to reduce the temperature of the cooking utensil when the measured temperature indicates that an unsafe operating condition exists or is imminent; and
a remote device in communication with the cooking appliance through the communication module, the remote device being configured to perform at least one of receiving appliance operating status information from the cooktop control unit or sending at least one control command to the cooktop control unit.

16. The fire prevention and control system of claim 15, wherein the control command comprises at least one of:
reducing the power of, or turning off, the heating source;
setting a power level to which the cooking utensil should be heated;
locking the heating source in an “off” mode;
initiating a temperature-controlled cooking profile; and
operating the heating source according to a time-dependent cooking profile.

17. The fire prevention and control system of claim 15, wherein the appliance operating status information comprises at least one of:
an indication that an unsafe operating condition exists or is imminent;
a notification that the heating source's power level has been reduced to prevent an unsafe operating condition from occurring;
a measured temperature of the cooking utensil;
a power level of the heating source that is manually set at the cooktop appliance; and
an amount of time that the heating source has been energized.

18. The fire prevention and control system of claim 15, wherein the remote device is a mobile phone, a tablet computer, a desktop computer, a laptop computer, or other electronic device, and having a software application that allows a user to communicate with the cooking appliance.

19. The fire prevention and control system of claim 15, wherein the cooking appliance comprises an electric cooktop, the heating source is an electric heating element, and the energy control device is a relay for reducing or stopping electrical energy (i.e. power) delivered to the electric heating element.

20. The fire prevention and control system of claim 15, wherein the cooking appliance comprises a gas cooktop, the heating source is a gas burner, and the energy control device is an electronically-actuated gas valve for reducing or stopping the flow of gas (i.e. chemical energy) to the gas burner.
